(19) United States
(12) Patent Application Publication
(10) Pub. No.: US 2017/0313412 A1
(43) Pub. Date: Nov. 2, 2017

(54) DEVICE FOR REDUCING AERODYNAMIC DISTURBANCES IN THE WAKE OF AN AERODYNAMIC PROFILE BY VARIABLE-DISTRIBUTION BLOWING ON THE TOP SIDE AND THE UNDERSIDE

(71) Applicant: Airbus Operations (S.A.S), Toulouse (FR)

(72) Inventor: Jerome COLMAGRO, Toulouse (FR)

(21) Appl. No.: 15/499,230

(22) Filed: Apr. 27, 2017

(30) Foreign Application Priority Data
Apr. 27, 2016 (FR) 1653720

(51) Int. Cl. B64C 21/04; B64D 27/26; B64D 29/04; B64D 27/14; B64D 27/00

(52) U.S. Cl. CPC B64C 21/04; B64D 29/04; B64D 27/14; B64D 27/26; B64D 2027/005

(57) ABSTRACT

A device for reducing aerodynamic disturbances in the wake of an aerodynamic profile. The device comprises a first air ejection nozzle arranged on the top side of the profile and a second air ejection nozzle arranged on the underside of the profile. A first blowing chamber is fluidically connected to the first nozzle and a second blowing chamber is fluidically connected to the second nozzle. Air supply means are configured to vary the distribution of air between said first blowing chamber and second blowing chamber. The distribution of the blown air can thus be adapted depending on the situation in which the profile is used, for example depending on the flight phase of an aircraft equipped with such a profile. Also, an aerodynamic profile, a pylon supporting a propulsion assembly for an aircraft comprising such an aerodynamic profile, and an aircraft.

### CROSS REFERENCE TO RELATED APPLICATIONS

This application claims priority to French Patent Application No. 1,653,720 filed on Apr. 27, 2016, the entirety of which is incorporated herein by reference.

### FIELD OF THE INVENTION

The invention relates to a device for reducing aerodynamic disturbances in the wake of an aerodynamic profile by blowing air on the top side and on the underside of said profile.

According to one particular embodiment, the invention relates to a pylon supporting a propulsion assembly for an aircraft comprising such an aerodynamic profile, and to an aircraft comprising such a pylon.

When a vehicle is in motion, any aerodynamic profile of that vehicle is exposed to the wake of other profiles of the vehicle, or to phenomena that disturb its boundary layer. This applies in particular to aircraft having propulsion assembly(ies) positioned on a pylon since the pylon—whatever its design—produces a wake.

This is due in particular to the fact that the thickness of the boundary layer of the profile of the pylon increases in the downstream direction of the profile.

This gives rise, at the trailing edge of the pylon, to a “velocity defect” (or “velocity deficit”) in the form of a difference between the free stream velocity and the local air velocity in the region downstream of the profile.

The region having this velocity defect also experiences a “mass flow defect” (or “mass flow deficit”) of air. This means that air tends to be drawn in to the velocity defect region, which causes turbulence.

In the case of a pylon supporting a propulsion assembly, in particular of the type having propellers or unducted blades, the velocity discontinuity and the turbulence in the wake cause, among other things, an increase in the noise generated by the propellers of the turbine of the propulsion assembly, which can be negative both in terms of passenger comfort and in environmental terms, when said rotors pass through the wake of the pylon. This is referred to as a “masking” effect.

There is therefore a need to limit this “masking” effect that causes pressure variation in the wake of the pylon.

In the specific case of pylons supporting propulsion assemblies, there is a need to eliminate the air flow deficit and therefore reduce the velocity deficit over the surface thereof.

One of the solutions to achieve this involves blowing air from a high-pressure source close to the trailing edge of the profile in order to eliminate the air flow deficit and thus reduce the velocity deficit.

To that end, U.S. Pat. No. 4,917,336 describes an air ejection device comprising an ejection nozzle sending air which escapes through slots created in the top side and the underside of a pylon supporting an aircraft propulsion assembly. However, this document presents complex embodiments.

The devices known in the prior art had a drawback that remains unresolved to this day. When the angle of attack of an aerodynamic profile varies, the air pressure on the top side and the underside also varies. This pressure is linked to the mass flow of air flowing respectively over the top side and the underside. When an aerodynamic profile is at a high angle of attack, which is in particular the case during the takeoff and landing phases (positive angle of attack) and in the approach phases (negative angle of attack) of an aircraft, the pressure difference between the top side and the underside of the profile is very large. More precisely, the pressures and air flows at the underside and the top side of the profile are very different, compared to the situation when the aircraft is in its cruising attitude. With the aerodynamic profiles currently used on commercial aircraft for the pylons for propulsion units (which play no significant part in generating lift), the pressures and air flows at the top side and the underside of the profile are identical or of the same order in the cruising attitude.

However, the known air ejection devices are configured to effectively reduce aerodynamic disturbances and noise in the cruising attitude but their effectiveness could be improved in those phases in which the pressures, air flows and therefore the mass flow deficits at the top side and the underside of the profile are very different.

### SUMMARY OF THE INVENTION

The invention aims to propose a device for reducing aerodynamic disturbances in the wake of an aerodynamic profile by ejection of air, with which it is possible to optimize the effectiveness thereof, in terms of limiting noise and aerodynamic disturbances, in all the phases of use of the aerodynamic profile equipped therewith.

According to a first aspect, the invention relates to a device for reducing aerodynamic disturbances in the wake of an aerodynamic profile, comprising a profile section formed so as to constitute a portion of the aerodynamic profile, said profile section comprising: a top side and an underside, a first air ejection nozzle (51) opening onto the top side, a second air ejection nozzle (52) opening onto the underside.

The device comprises a first blowing chamber fluidically connected to the first nozzle, a second blowing chamber fluidically connected to the second nozzle, and air supply means suitable for supplying air to said first blowing chamber and second blowing chamber, and suitable for varying the distribution of air between said first blowing chamber and second blowing chamber.

The invention thus provides a device with which it is possible to blow air at the top side and the underside of an aerodynamic profile, wherein the quantity of air blown can be controlled, that is to say distributed, independently at the top side and the underside in order to allow for variations in pressure differences between the top side and the underside according to the use of an aerodynamic profile, for example according to the flight phases of an aircraft equipped with such an aerodynamic profile.

According to one embodiment, the air supply means comprise a first distributor tube suitable for supplying air to the first blowing chamber, and a second distributor tube suitable for supplying air to the second blowing chamber.

The first distributor tube may extend into the first blowing chamber and comprise a plurality of openings distributed over a length of said first distributor tube, and the second distributor tube may extend into the second blowing chamber and comprise a plurality of openings distributed over a length of said second distributor tube.

The air supply means may comprise a common air inlet conduit for the first blowing chamber and the second blowing chamber, and an air distributor configured to distribute the air arriving via the air inlet conduit between said first blowing chamber and said second blowing chamber.

The air distributor may comprise a first controllable valve and a second controllable valve, the first valve being configured to permit or prevent entry of air into the first blowing chamber, the second valve being configured to permit or prevent entry of air into the second blowing chamber.

The first valve may be arranged at an inlet of the first distributor tube and the second valve may be arranged at an inlet of the second distributor tube.

The first valve and the second valve may each comprise a flap that rotates about a transverse axle, and an actuator that controls the rotational position of the valve.

The means for supplying air to the first blowing chamber and to the second blowing chamber may comprise a control system configured to control the supply of air respectively to the first chamber and to the second blowing chamber depending on the angle of attack of the profile and/or on the relative speed of the profile in the air.

According to another aspect, the invention relates to an aerodynamic profile of an aircraft comprising a device as previously described. The trailing edge of the aerodynamic profile may be a trailing edge assembly comprising the profile section.

According to another aspect, the invention relates to a pylon supporting a propulsion assembly for an aircraft comprising an aerodynamic profile as previously described. In such a pylon, the air supply means of the first blowing chamber and of the second blowing chamber may be supplied with air by the propulsion assembly.

The propulsion assembly may be of the type having unducted propulsion blades.

According to another aspect, the invention relates to an aircraft comprising a pylon supporting a propulsion assembly for an aircraft as previously described.

According to a final aspect, the invention relates to a method for reducing aerodynamic disturbances in the wake of an aerodynamic profile as previously described, said method involving distributing the air between the first blowing chamber and the second blowing chamber depending on the angle of attack of the profile and/or on the relative speed of the profile in the air.

### BRIEF DESCRIPTION OF THE DRAWINGS

In the appended drawings, provided by way of non-limiting examples:

FIG. 1 shows, in a schematic three-dimensional view, a fuselage F of an aeroplane comprising a propulsion system;

FIG. 2 shows, in a schematic three-dimensional view, a pylon for an aircraft propulsion assembly in its immediate environment;

FIG. 3 shows, in a schematic three-dimensional view, an example of the make-up of an aircraft propulsion assembly pylon;

FIGS. 4A to 4C show, schematically, an aerodynamic profile in cross section, in three different situations;

FIG. 5A shows, in a cross-sectional concept diagram, a device for ejecting air at the top side and the underside of an aerodynamic profile as known in the prior art;

FIG. 5B shows, in a cross-sectional concept diagram similar to FIG. 5A, a device for ejecting air at the top side and the underside of an aerodynamic profile according to an embodiment of the invention;

FIG. 6 shows, in a schematic three-dimensional view, certain aspects of the embodiment of FIG. 5B;

FIG. 7 is an enlarged perspective view of part of the device of FIG. 6; and,

FIGS. 8A to 8C show a valve that can be implemented in an embodiment of the invention, in three positions.

### DETAILED DESCRIPTION OF EMBODIMENTS OF THE INVENTION

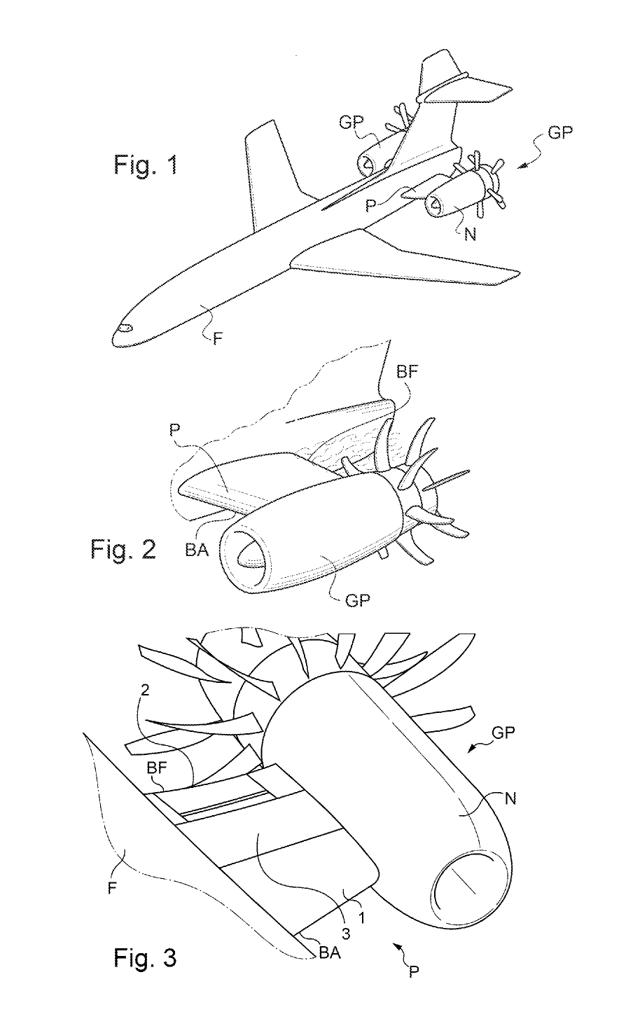

FIG. 1 shows a fuselage F of an aeroplane equipped with two propulsion units which comprise a motor (in this case a turbine) contained in a nacelle N and one or more thrust rotors, each comprising blades. A propulsion unit GP and its nacelle N form an aircraft propulsion assembly.

This nacelle N is supported and connected to the fuselage F by a pylon P. A pylon P is a structural and functional part connecting a propulsion unit GP of an aircraft to the structure (for example the fuselage F) of the aircraft. In particular, a pylon comprises an aerodynamic fairing surrounding a structure which supports the propulsion assembly and the devices that can be connected thereto. The latter are not shown.

As explained previously, in flight, the pylon P causes eddies in its wake and turbulence illustrated in FIG. 2.

FIG. 2 represents in more detail a propulsion assembly pylon P of an aircraft in its immediate environment. In order to limit aerodynamic drag the pylon has an appropriate aerodynamic profile provided by its fairing. An aerodynamic profile of this kind includes a leading edge BA and a trailing edge BF.

When the blades of a rotor, for example of a propfan as propulsion unit, pass through the wake of the pylon P, this can generate a large amount of noise since the blades experience aerodynamic disturbances and the “masking” effect that it generates.

Although aircraft propulsion assembly pylons are a preferred application of the invention, a similar effect can arise at a great many other elements of an aircraft, and the solution proposed in the invention can in general be applied thereto.

FIG. 3 shows a possible make-up of an aircraft propulsion assembly pylon.

The pylon P bears a propulsion unit GP. In particular, the pylon P connects—structurally and functionally—the fuselage F of an aircraft to the nacelle N of the propulsion unit GP. The aerodynamic profile of the pylon may be made up of multiple parts. For example, as shown in FIG. 3, the leading edge may consist of a leading edge assembly 1. The trailing edge may consist of a trailing edge assembly 2. The leading edge assembly 1 and the trailing edge assembly 2 are attached to an intermediate part 3.

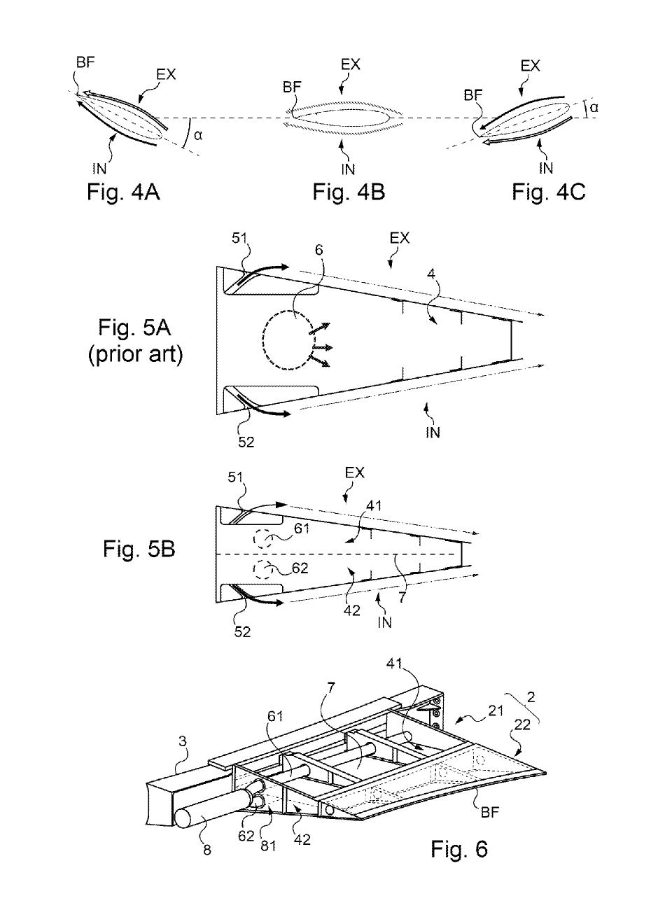

FIGS. 4A to 4C show an aerodynamic profile, for example an aerodynamic profile of an aircraft propulsion assembly pylon, in three different situations of use (or flight phases). In the three flight phases represented here, the aerodynamic profile has a different angle of attack α, also referred to as the incidence of the profile.

The angle of attack α, or incidence, corresponds to the angle formed between the chord of the aerodynamic profile and the general trajectory of the fluid (in this case air for an aircraft aerodynamic profile) through which the aerodynamic profile is moving.

FIG. 4A corresponds for example to an approach phase of an aircraft, that is to say a descent phase of the aircraft prior to landing. In this situation, the profile has an angle of attack α that is referred to as negative. In comparison to the situation in cruising attitude, shown in FIG. 4B described below, the air flow is accelerated at the underside IN of the profile, and a relative reduced pressure is generated at the underside IN, whereas the air pressure increases at the top side EX. The air flow along the underside IN of the aerodynamic profile thus arrives at the trailing edge BF with a higher speed than that of the air flow along the top side EX of the aerodynamic profile. Thickening of the boundary layer and the mass flow deficit arise predominantly at the underside IN. The need for blown air, in order to limit disturbances, is greater at the underside IN.

FIG. 4B shows the aerodynamic profile of FIG. 4A when the aircraft equipped with said profile is in the cruising attitude. In this situation, the angle of attack α is zero or approximately zero. In the case of a bi-convex profile such as frequently used for an aircraft propulsion assembly pylon, this zero angle of attack α reduces the aerodynamic drag generated by the profile. In this cruising-attitude situation, the air flow at the underside IN of the aerodynamic profile is identical or essentially identical to the air flow at the top side EX of the aerodynamic profile.

FIG. 4C shows the aerodynamic profile of FIGS. 4A and 4B when it is at a positive angle of attack α. Such a situation arises in particular in the takeoff and landing phases of an aircraft and, to a lesser extent, during climbing phases. In this situation, reduced pressure is generated at the top side EX of the aerodynamic profile, compared to the air pressure at the underside IN of said aerodynamic profile. Moreover, the pressure at the underside IN of the aerodynamic profile is higher than the pressure at the underside IN in cruising attitude. The air flow along the top side EX of the aerodynamic profile arrives at the trailing edge with a higher speed than that of the air flow along the underside IN of said aerodynamic profile. Thickening of the boundary layer and the mass flow deficit arise predominantly at the top side EX. The need for blown air, in order to limit disturbances, is greater at the top side EX.

As a result, depending on the life situation of an aerodynamic profile, for example depending on the flight phase of an aircraft equipped with this profile, the aerodynamic disturbances generated at the trailing edge BF of the profile are generated predominantly due to the air flow along the top side or due to the air flow along the underside, or essentially equally by the respective air flows along the top side and the underside.

FIGS. 5A and 5B compare, in similar schematic views, a device known from the prior art (shown in FIG. 5A) that is designed to reduce aerodynamic disturbances generated at the trailing edge of an aerodynamic profile, and an embodiment of the invention (shown in FIG. 5B). Therein, the profile portion constituted by the device is shown schematically in cross section.

FIG. 5A shows a device for ejecting air at the top side EX and at the underside IN of an aerodynamic profile as known in the prior art. Such a device comprises a blowing chamber 4 created in the thickness of the aerodynamic profile (that is to say in the thickness of that portion of the aerodynamic profile formed by the device).

The blowing chamber 4 is configured so as to be able to be pressurized. It supplies a first air ejection nozzle 51 opening at the top side EX of the aerodynamic profile, and a second air ejection nozzle 52 opening at the underside IN of the aerodynamic profile. In other words, the blowing chamber 4 is fluidically connected both to the first air ejection nozzle 51 and to the second air ejection nozzle 52.

An air ejection nozzle advantageously corresponds to an element having one or more air ejection openings, which element is oriented so as to blow air essentially tangentially to the surface of the aerodynamic profile towards the trailing edge of the latter. The air ejection opening(s) may have various shapes: they may for example take the shape of one or more slots that are transverse with respect to the surface of the aerodynamic profile.

The blowing chamber is supplied with air by supply means which may comprise a distributor tube 6 extending into said blowing chamber 4. The distributor tube 6 may comprise a plurality of openings distributed over its length. Such a tube is often referred to by the expression “piccolo tube”.

In the known devices, such as that shown in FIG. 5A, the first air ejection nozzle 51 and the second air ejection nozzle 52 are generally essentially identical such that an identical or similar quantity of air is ejected through each of said first air ejection nozzle 51 and second air ejection nozzle 52. Therefore, such a device is not adapted to all the life situations of an aerodynamic profile, in particular of an aircraft aerodynamic profile, which can have greatly varying angles of attack, as explained previously, in particular with reference to FIGS. 4A to 4C.

FIG. 5B shows, in a cross-sectional concept view similar to FIG. 5A, an embodiment of the invention.

Compared to the device of the prior art, a device as shown in FIG. 5B comprises two blowing chambers 41, 42 which are respectively configured to supply each one of the first and second air ejection nozzles 51, 52. In particular, a first blowing chamber 41 is configured to supply the first air ejection nozzle 51. A second blowing chamber 42 is configured to supply the second air ejection nozzle 52.

The means for supplying air to the first blowing chamber 41 and to the second blowing chamber 42 are configured so as to be able to supply air to each one of said first and second blowing chambers 41, 42 independently of one another.

The air supply means can thus comprise a first distributor tube 61 designed to supply air to the first blowing chamber 41, and a second distributor tube 62 designed to supply air to the second blowing chamber 42.

By adapting the quantity of air entering each one of the blowing chambers 41, 42, and accordingly the pressure prevailing in each one of said blowing chambers 41, 42, it is possible to independently control the quantity or proportion of air respectively ejected at the top side EX of the aerodynamic profile by the first air ejection nozzle 51, and at the underside IN of the aerodynamic profile by the second air ejection nozzle 52.

FIG. 6 shows, in a schematic three-dimensional view, a device according to an embodiment of the invention. In particular, FIG. 6 specifies certain details of the general embodiment shown in FIG. 5B.

According to the embodiment shown in FIG. 6, the device comprises a profile section 21 which, together with a second profile section 22, forms a trailing edge assembly 2. The trailing edge assembly 2 is attached to a structural intermediate part 3 of an aircraft propulsion assembly pylon (shown only partially in FIG. 6). The profile section 21 thus forms a portion of an aerodynamic profile of an aircraft pylon. A profile section is thus to be understood in general terms as a part of fixed or variable cross section which constitutes a portion of the aerodynamic profile.

In the thickness of the aerodynamic profile there are arranged a first blowing chamber 41 designed to supply air to a first air ejection nozzle 51 located at the top side of the aerodynamic profile (not shown in FIG. 6, where the upper surface of the profile is not shown), and a second blowing chamber 42 designed to supply air to a second air ejection nozzle 52 located at the underside of the aerodynamic profile.

The first blowing chamber 41 and the second blowing chamber 42 are separated from one another by a partition 7. The partition 7 may be located, as in the embodiment shown here, in the plane of the chord of the aerodynamic profile equipped with the device according to the invention. The partition 7 is airtight.

In the exemplary embodiment shown here, the means for supplying air to the first blowing chamber 41 and the second blowing chamber 42 comprise a common air inlet conduit 8 designed to bring the air destined for the blowing chambers 41, 42 close thereto. The air provided by the air supply means of the first and second blowing chambers 41, 42 can be provided by a propulsion assembly of the aircraft equipped with the invention. According to other embodiments, this air can be provided by a dedicated device or a device shared with other functions, such as an electric or mechanical compressor.

The air supply means also comprise an air distributor 81 arranged between the air inlet conduit 8 on one hand and, on the other hand, the first distributor tube 61 supplying the first blowing chamber 41 and the second distributor tube 62 supplying the second blowing chamber 42.

The distributor 81 is configured to split into two flows the air arriving through the air inlet conduit 8 and destined for the first blowing chamber 41 and the second blowing chamber 42.

The air distributor 81 can therefore be a Y-shaped splitter at the end of the air inlet conduit 8, as in the exemplary embodiment shown here.

Each of the branches of the distributor 81 is respectively connected to the first distributor tube 61 and to the second distributor tube 62.

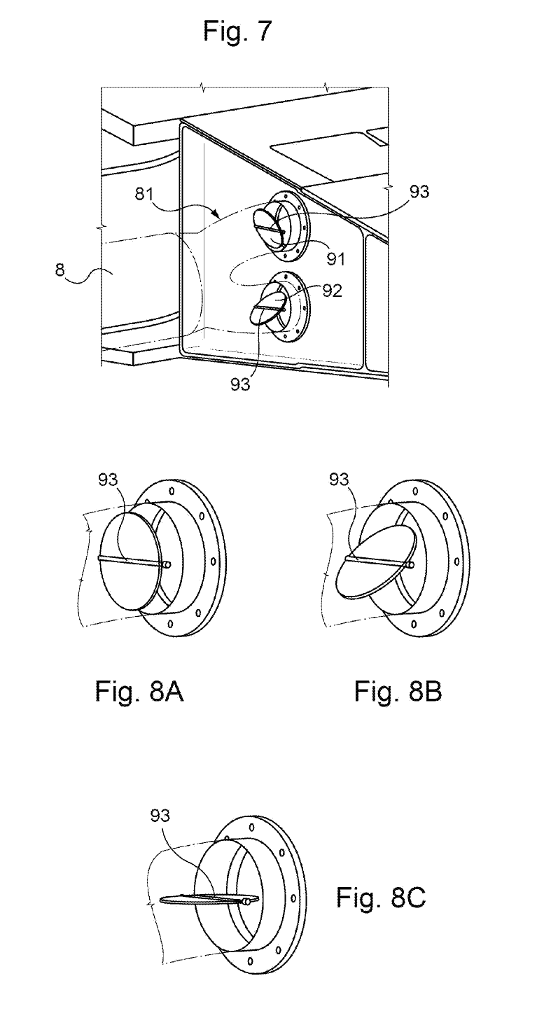

FIG. 7 presents a detail view of the device of FIG. 6 at the air distributor 81.

In the exemplary embodiment shown here, the air distributor 81 comprises a controllable valve at the outlet of each of the branches of the Y which it forms. More specifically, a first controllable valve 91 is arranged at the outlet of the air distributor 81 at the interface with the first distributor tube 61, and a second controllable valve 92 is arranged at the outlet of the air distributor 81 at the interface with the second distributor tube 62.

Each one of the first controllable valve 91 and the second controllable valve 92 can be controlled independently in order to permit or prevent the entry of air respectively into the first air distributor tube 61 and into the second air distributor tube 62. To that end, a control system (not shown) can be configured to independently control the respective opening and closure of the first valve 91 and of the second valve 92.

The first valve 91 and the second valve 92 may be butterfly valves, as in the case of the example shown here, that is to say that they comprise a flap that rotates about a transverse axle 93, about which the flap can swivel.

The first valve 91 and second valve 92 are each moved by an actuator controlled by the control system. Preferably, the first valve and second valve may each adopt any position between a closed position and an open position.

FIGS. 8A to 8C show a butterfly valve in three opening states.

FIG. 8A shows a butterfly valve—such as might be used in the embodiment of the invention shown—in the closed position, that is to say blocking the inlet of the air distributor tube 61, 62, at the inlet of which it is positioned. The corresponding blowing chamber 41, 42 is not supplied with air and the blowing of air via the air ejection nozzle 51, 52, to which said blowing chamber is fluidically connected, ceases.

Blocking an air distributor tube 61, 62, or more generally the fact of not supplying air to one of the two blowing chambers 41, 42, makes it possible for example to send all of the air provided by the air supply means to the other of said two blowing chambers 41, 42 in order that all of the available air is blown by the air ejection nozzle 51, 52, to which it is fluidically connected.

FIG. 8C shows a butterfly valve—such as might be used in the embodiment of the invention shown here—in the fully open position. This makes it possible for air to be supplied to the corresponding blowing chamber 41, 42.

Thus, when only one of the two blowing chambers 41, 42 is to be supplied, the valve corresponding to this blowing chamber to be supplied is controlled such that it adopts its fully open position, shown in FIG. 8C, while the valve of the other blowing chamber 41, 42 is positioned in the blocking position, as shown in FIG. 8A.

When the first blowing chamber 41 and the second blowing chamber 42 are to be supplied with an equivalent quantity of air, each of the valves corresponding respectively to the first blowing chamber 41 and to the second blowing chamber 42 is positioned in the fully open position, shown in FIG. 8C.

FIG. 8B shows a butterfly valve—such as might be used in the exemplary embodiment shown here—in a partially open position.

Such a partially open position makes it possible to allow a certain quantity of air to enter the corresponding blowing chamber 41, 42 while creating, at the inlet of said corresponding blowing chamber 41, 42, a loss of charge that can be adapted depending on the quantity of air that is to be made to enter said blowing chamber 41, 42, or depending on the pressure that is to be set in said blowing chamber 41, 42.

Thus, when an unequal distribution, between the first blowing chamber 41 and the second blowing chamber 42, of the air provided by the air supply means is desired, the control system advantageously sets the valve corresponding to the blowing chamber 41, 42 into which the majority air flow is desired to a fully open position (shown in FIG. 8C), and sets the valve corresponding to the blowing chamber into which the entry of a lesser quantity of air is desired to an appropriate intermediate position (similar to that shown in FIG. 8B).

The actuator for the butterfly valves used in the embodiment shown here may comprise an electric motor, preferably a motor of the stepper type that is connected to the transverse axle 93 of the butterfly valve by a train of pinions or any other suitable transmission means.

Thus, the device developed in the invention permits different and independent distribution of the air ejected respectively by the first air ejection nozzle 51 positioned at the top side EX of an aerodynamic profile, and by the second air ejection nozzle 52 positioned at the underside IN of said aerodynamic profile.

This makes it possible to adapt the quantity of air blown at the top side EX and at the underside IN depending on the differences in pressure and air flow along said underside IN and top side EX.

It is thus possible to optimize the effectiveness of a device for blowing air at the top side EX and the underside IN of an aerodynamic profile for all operational situations of the aerodynamic profile, and for example for all of the flight phases of an aircraft equipped with such an aerodynamic profile.

This optimization is preferably carried out automatically by the control system. Thus, the distribution of air between the first blowing chamber and the second blowing chamber may be set as a function of the angle of attack α of the profile and/or as a function of the relative airspeed of the profile. In an aeronautical application, the relative airspeed of the aerodynamic profile may generally be obtained using the speed sensors that are already present on the aircraft equipped with said aerodynamic profile. The angle of attack of the profile can generally be known using the inclination information of the aircraft equipped with the profile, which information is made available by sensors which precede the invention.

Of course, numerous types of controllable valves, preferably but not necessarily with progressive or proportional opening, may successfully be used in the invention. Thus, the use of a solenoid valve is in particular possible.

Similarly, although the invention has been described previously and represented in a preferred embodiment, numerous other embodiments and numerous variants are conceivable without departing from the scope of the invention.

For example, numerous types of separation between the first blowing chamber and the second blowing chamber may be envisaged instead of the partition 7 located in the plane of the chord of the profile shown. For example, the first blowing chamber 41 and the second blowing chamber 42 might be arranged at different levels along the cord of the profile and have a longitudinal separation with respect to the profile, or even be arranged side-by-side with a transverse separation between them.

In addition, the first blowing chamber 41 and the second blowing chamber 42 might not have an air distributor tube. They may optionally comprise other types of means for balancing out the air in order to ensure uniform blowing by the nozzle, for example over the entire length of said nozzle.

Although described in particular in relation to a pylon supporting an aircraft propulsion assembly, which constitutes a preferred application of the invention, the invention is applicable to numerous aerodynamic profiles, whether in the field of aeronautics or not. The invention is particularly applicable to the elements of the wing area of an aircraft.

In the context of application to a pylon supporting a propulsion assembly for an aircraft, the invention permits independent control of the distribution of the air blown between the top side and the underside of the aerodynamic profile of said pylon. This makes it possible, in particular when the pylon supports a propulsion assembly having unducted propulsion rotors, to optimize noise reduction in all flight phases of the equipped aircraft. That represents a significant element in compliance with current standards in respect of noise for certification of the aircraft. Furthermore, better control of the air masses blown at the top side and the underside of the aerodynamic profile make it possible to reduce the power to be provided by the propulsion unit supported by the pylon. In other words, it makes it possible to optimize the performance of the aircraft propulsion unit.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A device for reducing aerodynamic disturbances in the wake of an aerodynamic profile, comprising a profile section formed so as to constitute a portion of the aerodynamic profile, said profile section including a top side and an underside, a first air ejection nozzle opening onto the top side, a second air ejection nozzle opening onto the underside, and wherein the device comprises:
a first blowing chamber fluidically connected to the first nozzle;
a second blowing chamber fluidically connected to the second nozzle; and,
air supply means configured to supply air to said first blowing chamber and second blowing chamber, and configured to vary the distribution of air between said first blowing chamber and second blowing chamber.

2. The device according to claim 1, wherein the air supply means comprise a first distributor tube configured to supply air to the first blowing chamber, and a second distributor tube configured to supply air to the second blowing chamber.

3. The device according to claim 2, wherein the first distributor tube extends into the first blowing chamber and comprises a plurality of openings distributed over a length of said first distributor tube, and
wherein the second distributor tube extends into the second blowing chamber and comprises a plurality of openings distributed over a length of said second distributor tube.

4. The device according to claim 1, wherein the air supply means comprise a common air inlet conduit for the first blowing chamber and the second blowing chamber, and an air distributor configured to distribute the air arriving via the air inlet conduit between said first blowing chamber and said second blowing chamber.

5. The device according to claim 4, wherein the air distributor comprises a first controllable valve and a second controllable valve, the first controllable valve being configured to permit or prevent entry of air into the first blowing chamber, the second controllable valve being configured to permit or prevent entry of air into the second blowing chamber.

6. The device according to claim 5, wherein the first controllable valve is arranged at an inlet of the first distributor tube and the second controllable valve is arranged at an inlet of the second distributor tube.

7. The device according to claim 6, wherein the first controllable valve and the second controllable valve each comprise a flap that rotates about a transverse axle and an actuator that controls the rotational position of the respective flap.

8. The device according to claim 1, wherein the air supply means for supplying air to the first blowing chamber and to the second blowing chamber comprises a control system configured to control a supply of air respectively to the first chamber and to the second blowing chamber depending on at least one of an angle of attack of the profile and a relative speed of the profile in the air.

9. A device for reducing aerodynamic disturbances in the wake of an aerodynamic profile, comprising:
an aerodynamic profile having a first nozzle opening on a top side of the aerodynamic profile and a second nozzle opening on a bottom side of the aerodynamic profile;
a first blowing chamber fluidically connected to the first nozzle;
a second blowing chamber fluidically connected to the second nozzle; and,
air supply means configured to supply air to said first blowing chamber and second blowing chamber, and configured to vary the distribution of air between said first blowing chamber and second blowing chamber.

10. The device according to claim 9, wherein the aerodynamic profile comprises a trailing edge of a trailing edge assembly.

11. The device according to claim 9 further comprising:
a pylon having the aerodynamic profile and supporting a propulsion assembly for an aircraft.

12. The device according to claim 11 wherein the air supply means is supplied with air by the propulsion assembly.

13. The device according to claim 11 wherein propulsion assembly has unducted propulsion blades.

14. The device according to claim 11, wherein the pylon is secured to the aircraft.

15. A method for reducing aerodynamic disturbances in the wake of an aerodynamic profile having a first nozzle opening on a top side of the aerodynamic profile and a second nozzle opening on a bottom side of the aerodynamic profile, the method comprising:
distributing the air between a first blowing chamber fluidically connected to the first nozzle and a second blowing chamber fluidically connected to the second nozzle depending on at least one of an angle of attack of the aerodynamic profile and a relative speed of the aerodynamic profile in the air.
